(19) United States
(12) Patent Application Publication
(10) Pub. No.: US 2019/0011968 A1
(43) Pub. Date: Jan. 10, 2019

(54) TYPE-C PD Intelligent Converter

(71) Applicant: Yong-Bin Wang, Shenzhen (CN)

(72) Inventor: Yong-Bin Wang, Shenzhen (CN)

(21) Appl. No.: 15/644,784

(22) Filed: Jul. 9, 2017

(51) Int. Cl. G06F 1/26; G06F 13/42; G06F 13/40

(52) U.S. Cl. CPC G06F 1/266; G06F 13/4068; G06F 13/4282

(57) ABSTRACT

This invention discusses on the power source of adapter. Its focus is a TYPE C PD intelligent converter which is equipped with a connecting device and a microprocessor used to set and save the information of electric equipment; the microprocessor links up with TYPE C PD adapter via the connecting device, and receives the list of TYPE C PD adapter's voltages and corresponding currents offered by CC wire broadcasting; the microprocessor is used for the communication of the TYPE C PD adapter so that TYPE C PD adapter can output the voltage and current required by the electric equipment. The TYPE C PD intelligent processor can address the problem about the compatibility between the new and old products in the promotion and application of TYPE C, and reduces the inconvenience caused to users who need to buy and carry multiple USB cables or adapters with them.

### TECHNICAL FIELD

This invention discusses on the technical field of Universal Series Bus, particularly a TYPE C PD intelligent converter.

### TECHNICAL BACKGROUND

As a new interface, USB-C interface will face problems about device compatibility for some period to come. Most of the time, conversion devices are not available in the absence of adapters prior to the wide use of this interface, such as USB-C to USB Adapter, USB-C Digital AV Multiport Adapter, and USB-C VGA Multiport Adapter. In addition, there is also a need for USB TYPE-C power adapter.

Though USB TYPE-C is compatible with the old USB standards, users have to buy an extra adapter for the sake of compatibility. Since there are not enough USB TYPE-C adapters in the market, and few computers and mobile phones are equipped with USB TYPE-C interfaces, users have to carry a suitable USB cable with them when going out or even use the standard USB TYPE-C cable when charging the mobile phones. This may cause much convenience to users if they are required to carry at least two USB cables with them when going out.

### INVENTION CONTENTS

In consideration of this, there is a need to create a TYPE C PD intelligent converter that can avoid the inconvenience of carrying multiple USB cables due to the low compatibility of USB TYPE-C interface and its narrow scope of application.

The TYPE C PD intelligent converter is equipped with a connecting device and a microprocessor used to set and save the information of electric equipment.

The microprocessor links up with TYPE C PD adapter via the connecting device.

The microprocessor receives the list of TYPE C PD adapter's voltages and corresponding currents offered by CC wire broadcasting

The microprocessor is used for the communication of the TYPE C PD adapter so that TYPE C PD adapter can output the voltage and current required by the electric equipment.

In one of the cases, the preset module is utilized to save the preset information of the electric equipment so that the microprocessor can set, modify and save the information of the electric equipment through the connecting device.

In one of the cases, the microprocessor is equipped with a matching module and an acquisition module; the acquisition module is intended for acquisition of the information about electric equipment, and the matching module is aimed at matching the preset information of the electric equipment with the actual one; when the aforesaid preset information consists with the actual one, a most appropriate power supply mode may be selected for the electric equipment from the voltage and current list of TYPE C PD adapter for the purpose of sending request packet to TYPE C PD adapter.

In one of the cases, the connecting device is comprised of a TYPE C coupler and/or a USB cable; the TYPE C coupler and/or USB cable are intended for signal receiving or sending as well as for energy transmission.

In one of the cases, there is a signal processing network, through which the microprocessor is linked to the electric equipment.

In one of the cases, the microprocessor is microcontroller or information processing circuit.

Through the TYPE C PD intelligent converter, the electric equipment can be replaced by microprocessor to send an order of “receiving” to TYPE C PD adapter which can convert the internal voltage. The VBUS of TYPE C PD adapter applies new supply voltage after negotiation for the purpose of offering the voltage suitable for the electric equipment, addressing the problem about the compatibility between the new and old products in the promotion and application of TYPE C, and reducing the inconvenience of carrying multiple USB cables or adapters.

### EXPLANATIONS ON FIGURES

FIG. 1A: Flow Chart 1 for TYPE C PD Intelligent Converter in One of the Cases;

FIG. 1B: Flow Chart 2 for TYPE C PD Intelligent Converter in One of the Cases;

FIG. 1C: Flow Chart 3 for TYPE C PD Intelligent Converter in One of the Cases;

FIG. 1D: Flow Chart 4 for TYPE C PD Intelligent Converter in One of the Cases;

FIG. 2: Structural Diagram of Connecting Device in One of the Cases;

FIG. 3: Structural Diagram of TYPE CD Adapter in One of the Cases; and

FIG. 4: Structural Diagrams of Microprocessor and Preset Module in One of the Cases.

### SPECIFIC IMPLEMENTATION MODE

Figures are used to explain the details of the invention's specific implementation modes for the sake of a better understanding of the invention's objectives, features and advantages. Much attention is paid to descriptions on the specific details for the sake of better understanding about this invention. Nevertheless, this invention can be implemented in various ways different from the one described herein. The technicians in this field can make similar improvements without going against the intention of the invention. Hence, the invention is not restricted by the specific cases illustrated below.

The TYPE C PD intelligent converter is equipped with a connecting device and a microprocessor used to set and save the information of electric equipment; the microprocessor links up with TYPE C PD adapter via the connecting device, and receives the list of TYPE C PD adapter's voltages and corresponding currents offered by CC wire broadcasting; the microprocessor is used for the communication of the TYPE C PD adapter so that TYPE C PD adapter can output the voltage and current required by the electric equipment.

Specific descriptions will be made according to figures and cases.

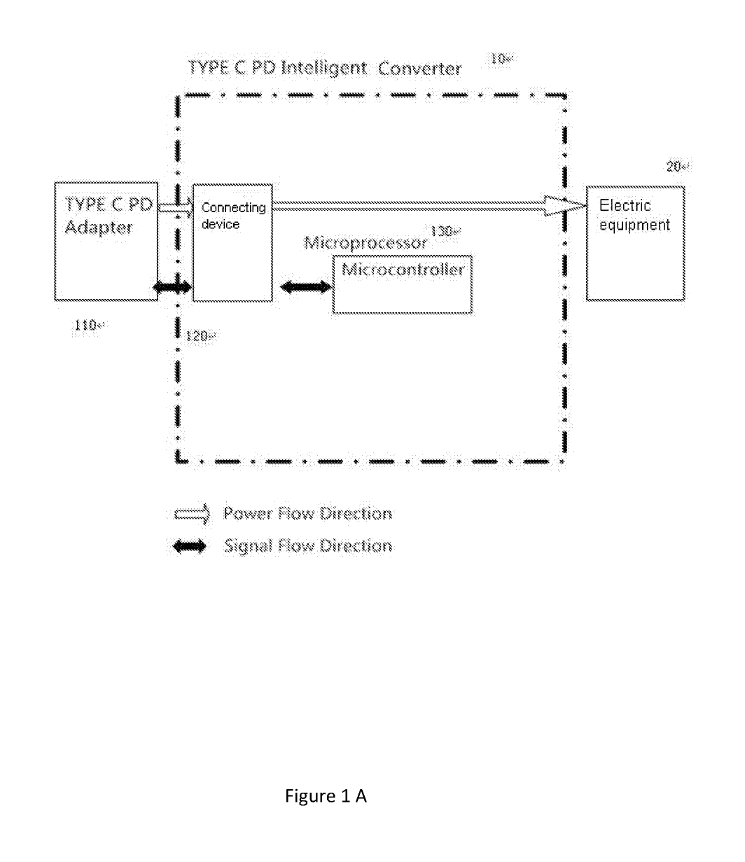

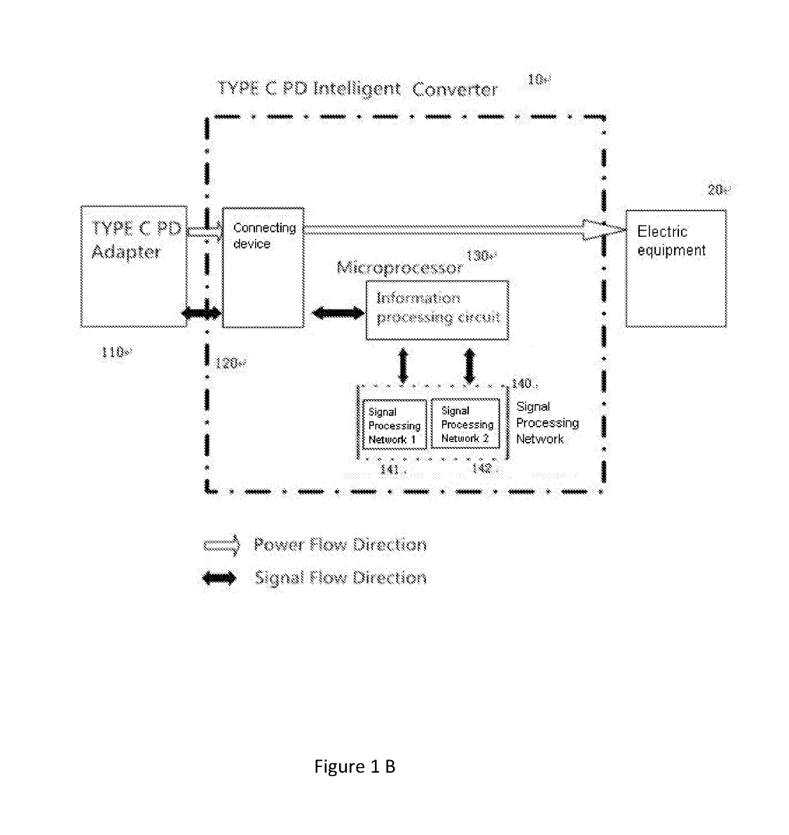

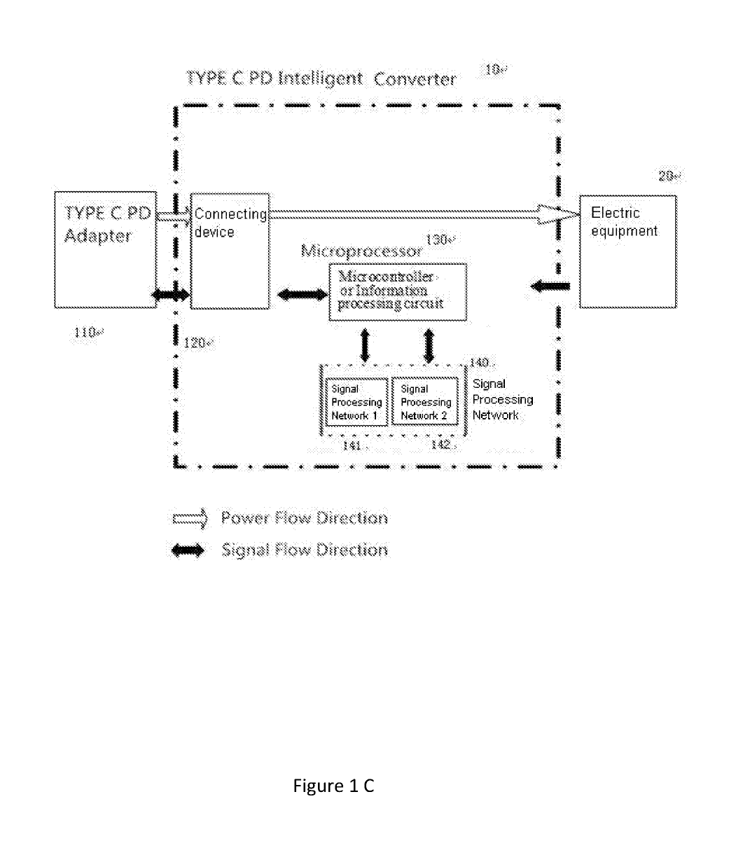

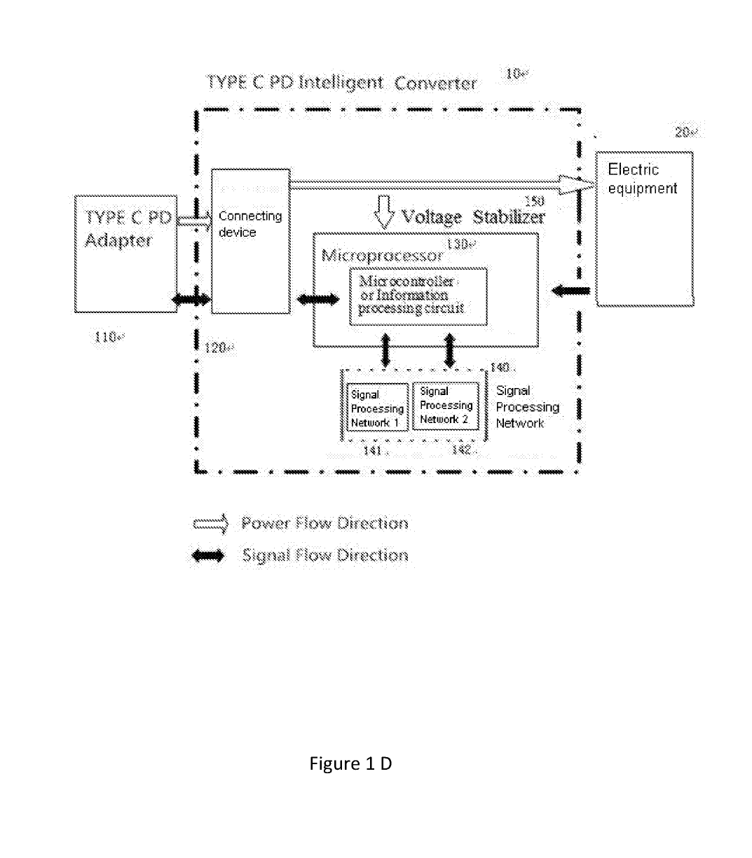

As revealed by FIGS. 1A, 1B, 1C and 1D, the TYPE C PD intelligent converter 10 is armed with a connecting device 120, a microprocessor 130, and a signal processing network 140.

The microprocessor 130 links up with TYPE C PD adapter 110 through the connecting device 120 to get the information of the adapter 110; the microprocessor 130 can read the information of the electric equipment 20 saved or preset in preset module or link up with the electric equipment 20 to obtain its information.

The microprocessor 130 receives the list of TYPE C PD adapter's 110 voltages and corresponding currents offered by CC wire broadcasting.

The microprocessor 130 which receives or derives the information of the electric equipment 20 selects a most suitable power supply mode for electric equipment 20 from the voltage and current list according to its information and sends the request packet to TYPE C PD adapter 110. Then, TYPE C PD adapter 110 conducts a negotiation in line with the request packet of the microprocessor 130, and then sends an order of “receiving” after evaluating its own abilities. In this way, TYPE C PD adapter 110 may convert internal voltage in accordance with the request packet of the microprocessor 130 and send “power good signal” packet to the microprocessor 130 so that TYPE C PD adapter 110 may apply the new supply voltage to VBUS after negotiation and then offer the required voltage suitable for the electric equipment 20.

Through the TYPE C PD intelligent converter 10, the electric equipment 20 can be replaced by microprocessor 130 to send an order of “receiving” to TYPE C PD adapter 110 which can convert the internal voltage. The VBUS of TYPE C PD adapter 110 applies new supply voltage after negotiation for the purpose of offering the voltage suitable for the electric equipment 20, addressing the problem about the compatibility between the new and old products in the promotion and application of TYPE C, and reducing the inconvenience of carrying multiple USB cables or adapters.

In one of the cases, the microprocessor 130 is microcontroller or information processing circuit.

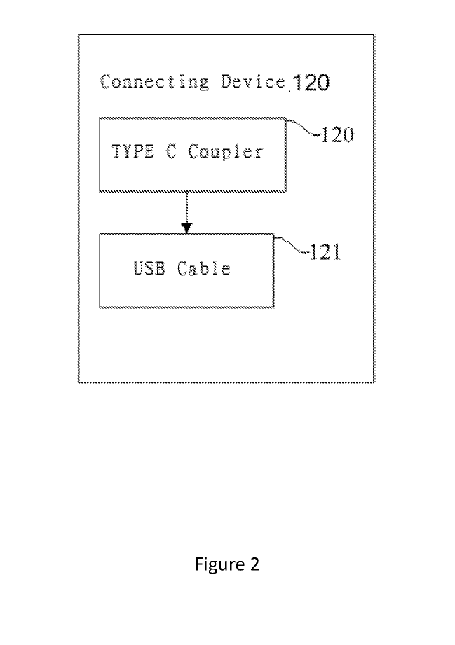

As revealed by FIGS. 1A, 1B, 1C, 1D and 2, the connecting device 120 in one of the cases is comprised of a TYPE C coupler 121 and a USB cable 122; the TYPE C coupler 121 and the USB cable 122 are intended for signal receiving or sending as well as for energy transmission.

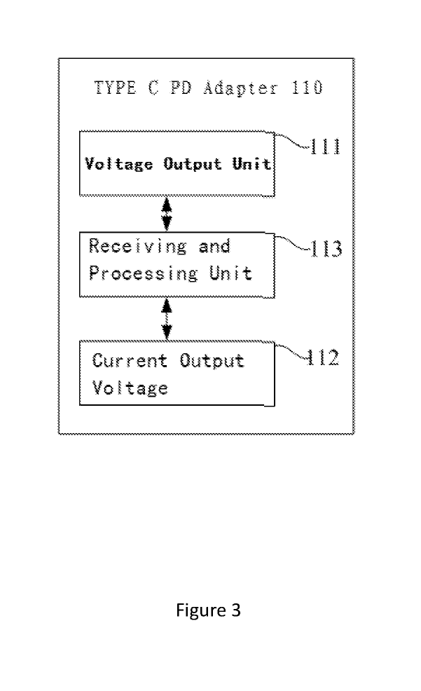

As revealed by FIGS. 1A, 1B, 1C, 1D and 3, the TYPE C PD adapter 110 in one of the cases is furnished with a voltage output unit 111, a current output unit 112, and a receiving and processing unit 113. The voltage output unit 111 and the current output unit 112 are linked to the receiving and processing unit 113.

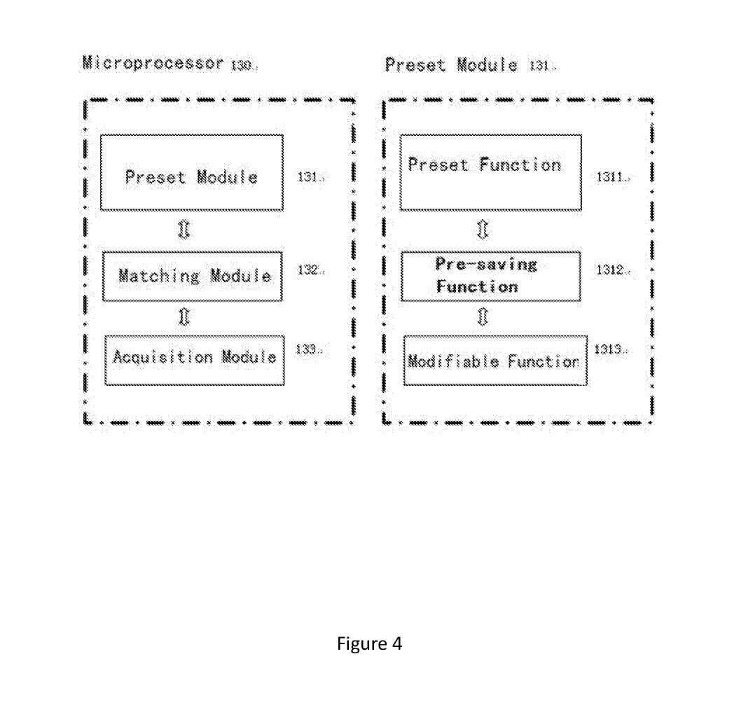

As shown FIGS. 1A and 4, the microprocessor 130 in one of the cases is armed with a preset module 131 and a matching module 132. The preset module 131 is intended to save the information of the electric equipment and the matching module 132 is used to match the preset information of the electric equipment 20. When the aforesaid preset information consists with the actual one, a most appropriate power supply mode may be selected for the electric equipment 20 from the voltage and current list of TYPE C PD adapter 110 for the purpose of sending request packet to TYPE C PD adapter 110.

As demonstrated by FIGS. 1A and 4, the microprocessor's preset module 131 in one of the cases is intended for pre-saving. The pre-saving function of the preset module 131 means setting, modifying and saving the information of the electric equipment beforehand by way of the connecting device 120.

As revealed by FIGS. 1B and 4, the microprocessor 130 in one of the cases is furnished with a preset module 131 used to preset the information of the electric equipment and a matching module 132 aimed at matching the preset information of the electric equipment 20. When the aforesaid preset information consists with the actual one, a most appropriate power supply mode may be selected for the electric equipment 20 from the voltage and current list of TYPE C PD adapter 110 for the purpose of sending request packet to TYPE C PD adapter 110.

As demonstrated by FIGS. 1B and 4, the microprocessor's preset module 131 in one of the cases is characterized by the pre-saving function. The pre-saving function of the preset module 131 means setting, modifying and saving the information of the electric equipment beforehand.

As revealed by FIGS. 1C and 4, the microprocessor 130 in one of the cases is furnished with an acquisition module 133 used to collect the information of the electric equipment 20, a matching module 132 exploited to match the information of the electric equipment 20, and a preset module 131 aimed at saving the information of the electric equipment 20. When the aforesaid preset information consists with the actual one, a most appropriate power supply mode may be selected for the electric equipment 20 from the voltage and current list of TYPE C PD adapter 110 for the purpose of sending request packet to TYPE C PD adapter 110.

As shown by FIGS. 1D and 4, the microprocessor 130 in one of the cases is armed with an acquisition module 133 used to collect the information of the electric equipment 20, a matching module 132 exploited to match the information of the electric equipment 20, and a preset module 131 aimed at saving the information of the electric equipment 20. When the aforesaid preset information consists with the actual one, a most appropriate power supply mode may be selected for the electric equipment 20 from the voltage and current list of TYPE C PD adapter 110 for the purpose of sending request packet to TYPE C PD adapter 110.

As demonstrated by FIGS. 1C, 1D and 4, the microprocessor's preset module 131 in one of the cases is characterized by the pre-saving function. The pre-saving function of the preset module 131 means setting, modifying and saving the information of the electric equipment beforehand.

In one of the cases, the TYPE C PD intelligent converter 10 is composed of a voltage stabilizer 150 which is connected to the microprocessor 130.

In one of the cases, the signal processing network 140 is comprised of the first signal processing channel 141 and the second signal processing channel 142.

The technical characteristics of the cases above can be combined with each other arbitrarily. For the sake of conciseness, the possible combinations of the technical characteristics above will not be described one by one. However, the combinations of these technical characteristics should be considered within the scope of this specification in the absence of contradictions.

The cases above only explain several implementation modes of this invention. Their descriptions are specific and detailed, whereas such descriptions should not be deemed as the constraints on the patent for invention. It is worth noticing that the changes and improvements made by the technicians in this field without contradicting the conceptions of this invention fall under the protective scope of this invention. Thus, the protective scope of the patent for invention shall be subject to the claim annexed.

What is claimed is:

1. The TYPE C PD intelligent converter is equipped with a connecting device and a microprocessor used to set and save the information of electric equipment.
The microprocessor links up with TYPE C PD adapter via the connecting device.
The microprocessor receives the list of TYPE C PD adapter's voltages and corresponding currents offered by CC wire broadcasting
The microprocessor is used for the communication of the TYPE C PD adapter so that TYPE C PD adapter can output the voltage and current required by the electric equipment.

2. As described by claim 1, the TYPE C PD intelligent converter is armed with a preset module which is intended to set and save the preset information of electric equipment so that the microprocessor can derive the preset information of the electric equipment from the preset module.

3. As described by claim 1, the TYPE C PD intelligent converter is featured with a microprocessor which consists of a matching module and an acquisition module; the acquisition module is intended for acquisition of the information about electric equipment, and the matching module is aimed at matching the preset information of the electric equipment with the actual one; when the aforesaid preset information consists with the actual one, a most appropriate power supply mode may be selected for the electric equipment from the voltage and current list of TYPE C PD adapter for the purpose of sending request packet to TYPE C PD adapter.

4. As described by claim 1, the TYPE C PD intelligent converter is characterized by a connecting device comprised of a TYPE C coupler and/or a USB cable; the TYPE C coupler and/or USB cable are intended for signal receiving or sending as well as for energy transmission.

5. As described by claim 1, TYPE C PD intelligent converter is equipped with a signal processing network, through which the microprocessor is linked to the electric equipment.

6. As described by claim 1, TYPE C PD intelligent converter's microprocessor is microcontroller or information processing circuit.
